(19) United States
(12) Patent Application Publication
(10) Pub. No.: US 2014/0162873 A1
(43) Pub. Date: Jun. 12, 2014

(54) MATERIALS AND METHODS FOR PRODUCTION OF ACTIVATED CARBONS

(71) Applicant: South Dakota State University, Brookings, SD (US)

(72) Inventor: Zhengrong Gu, Brookings, SD (US)

(73) Assignee: SOUTH DAKOTA STATE UNIVERSITY, Brookings, SD (US)

(21) Appl. No.: 13/939,722

(22) Filed: Jul. 11, 2013

Related U.S. Application Data
(60) Provisional application No. 61/670,375, filed on Jul. 11, 2012.

(51) Int. Cl. C01B 31/12

(52) U.S. Cl. CPC C01B 31/12
USPC 502/416; 423/460

(57) ABSTRACT

The invention is directed to improved methods for producing high-quality activated carbons from biochar. The invention also provides materials and methods for creation of activated carbons useful for purification of water, adsorption of gases or vapors, and catalyst supports. The methods include ash modification, physical activation, the addition of a catalyst, chemical activation, and removal and/or recycling of the catalyst. The usefulness of the present method is that it results in the production of a high-quality activated carbon from a waste product of the biofuel manufacturing process, thereby increasing the economic sustainability and viability of the biofuel production process itself.

### PRIORITY CLAIM

This application claims the benefit of U.S. Provisional Patent Application Ser. No. 61/679,375 filed Jul. 11, 2012.

### GOVERNMENT SUPPORT

The subject matter described herein was in-part made possible by support from the United States Department of Agriculture. The government may have certain rights in the invention.

### FIELD OF THE INVENTION

The present invention relates generally to methods for producing activated carbons from biochar, and more particularly, to the production of high-quality activated carbons with specifically-designed surface areas and pore volumes from high-ash containing starting biomaterials.

### BACKGROUND OF THE INVENTION

Biochar is a primary waste product produced in the manufacture of biofuels. Converting this waste product into something useable would greatly improve the economic sustainability and viability of the biofuel production process. One potential conversion product is activated carbons. Until recently, activated carbons based on herbaceous biomass, such as corn stover, corn cob, rice husk, peanut hull, waste tea, rice straw, cotton stalk, and soybean oil cake were generated with traditional physical activation utilizing steam and CO₂ chemical activation with sodium hydroxide, potassium hydroxide, or phosphoric acid; microwave activation; or supercritical water activation.

Unfortunately, all of the current processes are extremely expensive and not capable of producing high-quality activated carbons due to the high ash content in the starting herbaceous biomass material. The resulting products are also not useful for commercial purposes and not capable of being produced from waste products generated during the biofuel production process. Therefore, there is a need in the art for methods of manufacturing activated carbon compositions from biochar in order to increase the economic viability of the biofuel production process. There is also a need for methods of producing activated carbons having specifically designed surface areas and pore volumes. Activated carbons having specific characteristics would have the advantage of more effectively purifying water, cleaning the air of noxious gases, recovering solvents, supporting catalysts and storing energy.

### DETAILED DESCRIPTION OF THE INVENTION

### Definitions

For the purpose of the present invention, the following terms shall have the following meanings:

For purposes of the present invention, the term, “biochar” shall refer to any solid waste or co-product from a thermochemical process that has been optimized or otherwise designed to produce bioenergy or biofuel from a biomass source.

For purposes of the present invention, the term, “biomass” shall refer to any organic material generated through photosynthesis or a derivative of an organic material generated through photosynthesis.

Moreover, for the purpose of the present invention, the term “a” or “an” entity refers to one or more of that entity; for example, “a protein” or “a nucleic acid molecule” refers to one or more of those compounds or at least one compound. As such, the terms “a” (or “an”), “one or more” and “at least one” can be used interchangeably herein. It is also to be noted that the terms “comprising”, “including”, and “having” can be used interchangeably. Furthermore, a compound “selected from the group consisting of” refers to one or more of the compounds in the list that follows, including mixtures (i.e. combinations) of two or more of the compounds. According to the present invention, an isolated, or biologically pure molecule is a compound that has been removed from its natural milieu. As such, “isolated” and “biologically pure” do not necessarily reflect the extent to which the compound has been purified. An isolated compound of the present invention can be obtained from a natural source or can be produced by chemical synthesis.

### BRIEF DESCRIPTION OF THE DRAWINGS

FIG. 1 illustrates the raman shift profiles of a variety of exemplary activated carbon samples derived from the biochar of DDGS in accordance with an embodiment of the present invention.

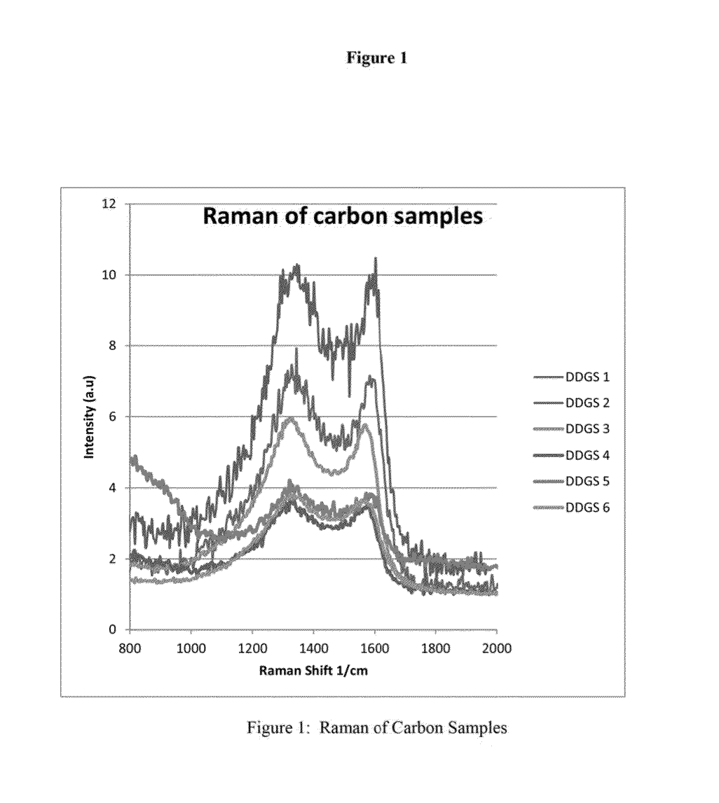

FIG. 2 illustrates the BET adsorption results of exemplary activated carbon samples derived from the biochar of DDGS in accordance with an embodiment of the present invention.

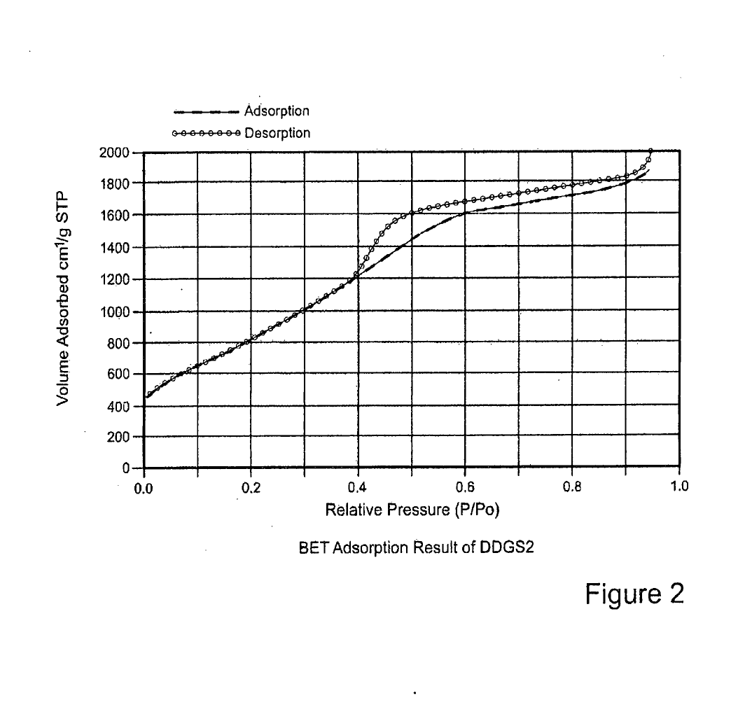

### BIOCHAR

Biochar of the present invention includes any solid waste or co-product generated through the gasification, pyrolysis or thermochemical conversion of a lignocellulosic biomass. Any carbonaceous biomass may be utilized in the methods of the present invention. In a particular embodiment, the biomass is selected from the group consisting of wood chips; saw dust; forest thinning residues; agricultural residues, such as switch grass, prairie cordgrass, big bluestem; fermentation residues, such as DDGS; food, grain or agricultural industries processing residues, such as rice husks, wheat bran, corn fiber, corn gluten, animal bones, shells of nuts, oil seed cakes after oil extraction or squeezing; products or derivatives from bioproducts, such as lignin, cellulose, hemicellulose, saccharides, polysaccharides, algae, yeast, fat and lipids and the like.

Biochar of the present invention may be produced by any method and one skilled in the art is familiar with techniques of producing biochar from biomass. Illustrative methods include, but are not limited to, gasification, slow pyrolysis, fast pyrolysis, hydrothermal pyrolysis or micropyrolysis, and activation via physical and/or chemical methods.

Production of Activated Carbons from Biochar

The present invention provides materials and methods for the production of activated carbons from biochar, where such activated carbons have specific surface area and pore volume characteristics. The methods of the present invention decrease the cost associated with making activated carbons and also increase the economic viability of the biofuel production process by utilizing a co-product or waste-product of the biofuel production process itself.

The methods of the present invention include a variety of steps to convert biochar to activated carbons. One or more of the steps may be useful for production of an activated carbon with particular characteristics. Not all steps will be used in the conversion process of all activated carbons. One skilled in the art will understand how to determine which steps are necessary to create the desired activated carbon product.

The steps include (1) modification of the ash content and distribution in the biochar, (2) control of the volatile composition of the biochar, (3) physical activation of the biochar, (4) catalyst loading for chemical activation of the biochar, (5) chemical activation of the biochar and (6) removal and recycling of the catalysts. Not all steps are necessary for production of all activated carbons and one skilled in the art is familiar with determining which steps are necessary for production of activated carbons demonstrating desired characteristics, such as high or low surface area, high or low pore volume and the like.

In one embodiment, the ash content of biochar may be modified and/or redistributed by any method known in the art. In a particular embodiment, removal of the ash content after activation creates activated carbon products suitable for medical and/or micro-electrical applications. Illustrative characteristics of activated carbons produced by a process that includes this step include, but are not limited to, a higher total pore volume and a higher mesopore volume. In a particular embodiment, the ash content is modified and/or redistributed with an agent selected from the group consisting of, but not limited to, water, one or more acids or one or more bases. Illustrative characteristics of the activated carbon produced by a process that includes this step include, but are not limited to, control over particle size and control over pore size distribution. In a particular embodiment, the pore size is reduced. Acids may be selected from the group consisting of hydrochloric acid, hydrofluoric acid, hydrobromic acid, nitric acid, sulfuric acid, phosphoric acid, acetic acid, citric acid, perchloric acid, and sulfurous acid. Bases may be selected from the group consisting of sodium hydroxide, potassium hydroxide, calcium hydroxide, sodium carbonate, potassium carbonate, sodium bicarbonate, potassium bicarbonate, ammonia hydrate. The agent selected may be in solution with the biochar for any period of time and/or at any temperature deemed effective to modify and/or redistribute the ash content of the biochar. In a particular embodiment, the agent is allowed to saturate the biochar for a time period ranging from 30 minutes to 24 hours at room temperature. In another particular embodiment, the saturation is done in conjunction with ultrasonic radiation or mechanic mixing. An illustrative protocol for the alteration of the ash content of biochar can be found in Example Six.

In another embodiment, the volatile composition of the biochar is controlled. In a particular embodiment, the volatile composition of the biochar is controlled while the ash content is being modified and/or redistributed. An illustrative characteristic of the activated carbon produced by a process that includes this step includes a change in pore size distribution. The volatile composition of the biochar may be controlled by any method known in the art. In a particular embodiment, the volatile composition of the biochar is controlled by using heat in an inert atmosphere. Any rate of heating and/or temperature may be utilized to achieve the de-volatile temperature required to alter the volatile composition of the biochar. An illustrative protocol for the control of the volatile composition of a biochar can be found in Example Seven.

In an additional embodiment of the present invention, the biochar is physically activated. Physical activation can be accomplished by any method known in the art. Illustrative characteristics of physical activation include asserting control over the rate of heating, temperature of activation, activation reagents, the flow rate of activation reagents, the mass/molar ratio of activation reagents to biochar and the activation time itself. The rate of heating may be any rate capable of physically activating the biochar. In a particular embodiment, the rate of heating is 1-40 C/minute. The temperature may be any temperature capable of physically activating the biochar. In a particular embodiment, the temperature is between 500-1200 C. The activation reagents may be any activation reagents capable of physically activating the biochar. In a particular embodiment, the activation reagents are selected from the group consisting of pure CO2, steam, air and a mixture containing CO₂, steam, CO, H₂ and/or CH₄. The flow rate of the activation reagent may also be any rate capable of causing physical activation of the biochar. In a particular embodiment, the rate of flow ranges from 0.01 cm/s to 1 m/s. The reaction time can be any time necessary to cause physical activation of the biochar. In a particular embodiment, the activation time is ten minutes. In another particular embodiment, the faster activation speed is obtained by applying ash components as catalysts. Illustrative ash components are alkaline-alkaline earth oxide, alkaline-alkaline earth carbonates, and transmission metal oxide. In another particular embodiment, the activation time ranges from less than two hours to more than several days. In an additional embodiment, the mass/molar ratio of activation reagent to biochar is controlled by alteration of the activation time. An illustrative characteristic of the activated carbon produced by a process that includes this step is an activated carbon demonstrating more micropores but less mesopores than those found in activated carbon produced by chemical activation.

In an additional embodiment of the present invention, a catalyst is utilized in the activated carbon process. Any catalyst capable of catalyzing the conversion of biochar to activated carbons may be used with the methods of the present invention. Illustrative characteristics important to consider when choosing a catalyst include the choice and composition of the particular catalyst, the mass/molar ratio of catalysts to biochar and the methodology used to add the catalyst to the biochar/carbon mixture. Illustrative examples of catalysts include, but are not limited to, hydroxides, carbonates or bicarbonates of alkali metals or nitrate of transition metals and their mixtures. In a particular embodiment, the catalysts include, but are not limited to, NaOH, KOH, Na₂CO₃, K₂CO₃, NaHCO₃, KHCO₃. Illustrative characteristics of the activated carbon produced by a process that includes this step includes, but is not limited to, a higher surface area, higher pore volume, higher mesopore volume, and lower yield. An illustrative protocol for the use of a catalyst in conjunction with chemical activation can be found in the activated carbon protocol illustrated in Example Nine.

In another embodiment of the present invention, the biochar is chemically activated. Any chemical capable of activating the biochar may be used with the methods of the present invention. Illustrative characteristics of chemical activation include asserting control over the rate of heating, temperature of activation, activation reagents, the flow rate of activation reagents, and the activation time itself. In a particular embodiment, the chemical activation agent is selected from the group consisting of, but not limited to, hydroxides or bicarbonates of alkali metals or nitrate of transition metals and/or a mixture thereof. In another particular embodiment, the chemical activation agent is selected from the group consisting of, but not limited to, NaOH, KOH, LiOH, Li₂CO₃, Na₂CO₃, K₂CO₃, KHCO₃, NaHCO₃, CsOH, Cs₂CO₃, Rb₂CO₃, RbOH, Fe(NO₃)₃, Ni(No₃)₂, CO(NO₃)₂ and mixtures of the same. In another particular embodiment, acidic chemical activation agents are utilized for high-ash content biomass materials to remove the ash containing salts and/or oxidants. In another particular embodiment, basic chemical activation agents are utilized to remove silica from biomass. Any mass ratio of chemical activation agents to biochar may be used with the present invention. In a particular embodiment, the mass ratio of chemical activation agent to biochar ranges from 0.1:1 to 10:1. Chemical activation agents can be added in any form capable of causing chemical activation of the biochar. In a particular embodiment, the chemical activation agents are added as solids, solutions or slurries. In a particular embodiment, the chemical activation agent is added as a solution. Any soaking time of the chemical activation agent with the biochar may be used with the methods of the present invention. In a particular embodiment, the soaking time ranges from 0.1 to 48 hours. Any temperature may be used with the chemical activation methods of the present invention. In a particular embodiment, the temperature ranges from 4 C to 100 C. In another particular embodiment, the temperature utilized is lower when the particle size is smaller to ensure even soaking of entire particles. The chemical may be added to the biochar and mixed with any mixing method known in the art. In a particular embodiment, an ultrasound treatment or other high speed (>6000 rpm) dispersing ball mill with high speed is utilized. An illustrative protocol for utilizing catalysts in conjunction with chemical activation in the production of activated carbons can be found in Example Seven. Illustrative characteristics of the activated carbon produced by a process that includes this step includes higher adsorption capacity and better adsorption capacity than activated carbons produced by physical activation. In a particular embodiment, a mixture of alkaline hydroxide and carbonate is utilized to generate a higher surface area in the resulting activated carbon than that found in activated carbons produced with just catalysts alone.

In another embodiment, chemical activation produces activated carbons with a higher adsorption capacity. In a particular embodiment, chemical activation involves the use of CO₂ and H₂O to produce activated carbons with increased specific surface area and adsorption capacity. An illustrative protocol for utilizing chemical activation in the production of activated carbons can be found in Example Nine.

In yet another embodiment, the catalyst may be removed and/or recycled. This may be done by any method known in the art. Issues to consider when determining appropriate removal and/or recycling include the methodology used to wash and remove catalysts. The catalysts such as Na₂CO₃ and K₂CO₃ have been successfully recovered after water wash, the solution of catalysts has been concentrated using heating and evaporation (i.e. boiling at 100 C). The recycled catalysts such as Na₂CO₃ and K₂CO₃ have been reused on different biochar, and the subsequent activation results did not appear different. For biochar with high SiO₂, such as rice husk, the recycling of catalysts will be difficult because base catalysts react with SiO₂ to generate silicate, which cannot be recycled directly.

All or a select few of the steps above may be utilized to create activated carbons possessing the desired characteristics. Particular steps and/or combinations of steps will produce particular characteristics in the resulting activated carbon. One skilled in the art will understand the particular steps and reagent conditions for each one that are important to create the activated carbon. Exemplary protocols using a variety of steps are illustrated below:
1. Ash modification→Physical activation=Activated Carbon
2. Physical activation→Ash modification=Activated Carbon
3. Ash Modification→Volatile modification→Catalyst addition→Chemical Activation→Removal and recycling of Catalyst=Activated Carbon
4. Volatile modification→Catalyst addition→Chemical activation→Catalyst removal and recycling=Activated Carbon
5. Ash modification→Physical activation→Chemical activation AND Catalyst addition→Catalyst removal and recycling=Activated Carbon
6. Ash modification→Catalyst addition→Chemical activation→Catalyst removal and recycling=Activated Carbon
7. Ash modification→Catalyst addition→Chemical activation→Physical activation→Catalyst removal and recycling=Activated Carbon

The methods of the present invention may be used by anyone that wishes to produce high-quality activated carbons with specific characteristics, such as high-surface area, high pore volume and the like. Illustrative end-users include, but are not limited to, existing activated carbon producers who wish to decrease the costs associated with their current production methods and biorefineries that wish to create a useable product from a co- or waste-product in order to decrease the costs associated with producing biofuels.

For the sake of illustration, production of an activated carbon having a high surface area and pore volume can be produced by utilizing physical activation for a prolonged period of time at a high temperature. Example One illustrates one such exemplary protocol. This same product can also be created using chemical activation with catalysts at a higher temperature. Example Two illustrates one such production protocol. Example Ten illustrates an additional step that can be done to activated carbon produced by chemical activation wherein it is washed with HNO₃ after production. Activated carbons washed in this manner appear to have a high specific surface area and improved specific capacitance. In contrast, production of an activated carbon having a low surface area and low pore volume can be produced utilizing physical activation for a short period of time at a low temperature or with chemical activation without catalysts at a low temperature. As another illustration of alteration of the protocol steps, an activated carbon demonstrating a high surface area, a high total pore volume and a high mesopore volume can be produced at a higher activation temperature but yield will decrease as the activation time is prolonged. Additionally, low-cost production of activated carbons with relatively low adsorption properties (BET<1200 m²/g) only requires physical activation. In contrast, production of high-quality activated carbons with high adsorption properties will require chemical activation. Additionally, production of activated carbons containing hierarchical porous structures will require both physical and chemical activation. One skilled in the art would understand how to alter the conditions of the various steps of the methods of the present invention to produce the appropriate activated carbon.

### Activated Carbons

The activated carbons of the present invention may be used for any purpose necessitating the need for them. Illustrative uses include, but are not limited to, water purification, air-cleaning, solvent recovery, catalyst supports and as an energy storage form. They may also be useful in the production of a super anode for a super capacitor or battery. One skilled in the art is well-versed in the use of activated carbons and will understand how to use those produced from the methods of the present invention.

In one embodiment of the present invention, the activated carbons have high pore volume and surface area. In a particular embodiment, the activated carbons have BET surface areas greater than 2000 m²/g. In another embodiment, the activated carbons of the present invention have total pore volumes higher than 1 ml/g. In an additional embodiment, the mesopore volumes are higher than 65% of the total pore volume. In another embodiment, the pore diameters are greater than 5 nm. In a specific embodiment, the pore diameters range from 1.7 nm to 5 nm. Illustrative uses for such activated carbons include adsorption, energy storage and catalysis.

In another embodiment, the activated carbons have low surface areas and high pore volumes. In a particular embodiment, the activated carbons have low surface areas less than 600 m²/g. In another embodiment, the mesopore volume is higher than 0.45 ml/g. In another embodiment, the average diameter is larger than 3.7 nm. Illustrative uses for such activated carbons include electrical energy storage.

In an illustrative embodiment, activated carbons demonstrating adsorption properties with a BET<1200 m²/g are used for a purpose selected from the group consisting of, but not limited to, waste-water purification, solvent recover and air purification. In another illustrative embodiment, activated carbons demonstration adsorption properties with a BET>1200 m²/g are utilized for a purpose selected from the group consisting of, but not limited to, the preparation of super-activated carbons for natural gas storage, H² storage, and electrical energy storage in a battery or supercapacitor.

For the sake of illustration, suggested standards for different applications that utilize activated carbon are listed below:

| | Iodine | Water | | N₂ BET | Pore | |
|---|---|---|---|---|---|---|
| | value | soluble | Total | specific | Volume | Apparent |
| Standard | mg/g | ash | ash | surface area | (N₂) | density |
| Solvent | >1000 | <15% | <20% | >1000 m2/g | >0.4 ml/g | >0.30 g/ml |
| recovery | | | | | | |
| Pharmaceutical | >1000 | <0.1% | <0.1% | >1500 m2/g | >1 ml/g | >0.2 g/ml |
| application | | | | | | |
| Supercapacitor | >1000 | <0.1% | <0.1% | >1500 m2/g | >1.5 ml/g | >0.2 g/ml |

### EXAMPLES

The following examples are included to demonstrate particular embodiments of the invention. It should be appreciated by those of skill in the art that the techniques disclosed in the examples which follow represent techniques discovered by the inventors to function well in the practice of the invention, and thus can be considered to constitute particular modes for its practice. However, those of skill in the art should, in light of the present disclosure, appreciate that many changes can be made in the specific embodiments which are disclosed and still obtain a like or similar result without departing from the spirit and scope of the invention.

### Example One

### Physical Activation to Prepare Water Purified Activated Carbon Protocol

High ash woody biochar from pine wood pyrolyzed at 600 C for 30 minutes, containing 15% ash and 12% volatiles was used as feedstock. The biochar was dried at 100 C for 12 hours to remove all moisture and then physically activated as described below.

Thirty grams of the dried biochar was then placed in a reactor fabricated with a 316 stainless steel screen (80 mesh). The reactor was then placed in a muffle furnace equipped with one gas inlet and one gas outlet at room temperature. The gas outlet was then utilized to turn on a N₂ flow (0.5 L/min) into the muffle furnace. The heat was then turned on and a heating rate of approximately 10 C/min was utilized while keeping the N2 flow at 0.5 L/min until a target temperature of 810 C was achieved. After the target temperature was reached, water (1 ml/min) was immediately added to the muffle furnace in conjunction with the N₂ gas flow to achieve steam activation. The chars were then steam activated at 810 C for 30 min. After steam activation, the whole reactor was taken out, and immersed in an ice-water bath immediately. The cooled activated carbon was then collected with vacuum filtration utilizing quantification filter paper.

The collected carbon was then dried at 105 C overnight, weighed to calculate yield of activation and stored in glass bottles in a vacuum desiccator. Ash was then removed with a HCl and NaOH shaker wash. The activated carbon was then mixed with 1 Mol/L HCl acid in a glass beaker utilizing a ratio of acid to carbon of 1 L:200 gram. The mixture was then placed on a shaker at 200 rpm at room temperature for 60 minutes. After the HCl wash, the carbon was then filtered using quantification filter paper.

The carbon product was then continually washed with deionized (“DI”) water under vacuum filtration until the pH of the filtrate was 7. The collected carbon was then dried at 105 C overnight, weighed to calculate yield of activation of the carbon and stored in a glass bottle in vacuum desiccator.

The activated carbon was then mixed with a 1 Mol/L NaOH solution in a polyethylene beaker where the ratio of base solution to carbon was 1 L:200 grams. The NaOH-carbon mixture was then placed in a shaker at 200 rpm, at room temperature for one hour. After the NaOH wash, the carbon was again filtered using quantification filter paper and continually washed with DI water under vacuum filtration until the pH of the filtrate was 7.

The collected carbon was then dried at 105 C overnight, weighed to calculate yield of activation and stored in a glass bottle in a vacuum desiccator.

### Analysis:

The data for the nitrogen adsorption-desorption isotherm at 77 K was analyzed using Micromeritics Accelerated Surface Area and Porosimetry Analyzer (ASAP 2010). The specific surface areas were calculated using the Brunauer-Emmett-Teller (BET) equation. The total pore volumes were obtained at relative pressure 0.99 P₀. The micropore volume was estimated using i-plot method, while mesopore volume was determined by the Barrett, Joyner, and Halenda (BJIH) theory.

The methylene blue adsorption was analyzed according to standard protocols. Briefly, a specific volume methylene blue solution 1.5 g/L in phosphate buffer (3.6 g KH₂PO₄ and 14.3 g Na₂HPO₄ in 1 L water, pH=7, no titration was permitted) was added to 0.1 g dried activated carbon (>90% pass 200 mesh or 71 um screen) and incubated for 10 minutes on a shaker (275 rpm) at room temperature. The slurry was then centrifuged at 5000 rpm for 5 minutes and filtered. The clarified sample was then quantified with spectrophotometer at 665 nm in a 1 cm cuvette. If the Ab of light was the same as a CuSO₄ solution (2.4 g CuSO4.5H2O in 100 ml water), the specific volume of methylene blue was used to calculate the adsorption amount. If the Ab of light was higher than CuSO₄ solution, the methylene blue solution volume was reduced and the assay repeated.

Table 1 illustrates the properties of the activated carbon produced by the protocol above:

TABLE 1

| Activation | Activation | Yield/% | Yield % based | BET | Vmeso/ | D | Methylene | Iodine |
|---|---|---|---|---|---|---|---|---|
| Temper- | time | Based on | on fixed C | SSA | Vtotal | pore/ | blue adsorp- | value |
| ature/C. | minutes | total biochar | in biochar | m2/g | ml/g | nm | tion mg/g | (mg/g) |
| 810 | 30 | 41% | 46% | 910 | 0.416/0.585 | 2.59 | 150 | 1150 |

Apparent Density of this activated carbon: 0.38 g/ml

### Total ash: <2.1%

Total volatile (at 900 C, 15 minutes): <0.1%
Heavy metals (by atoms fire spectroscopy): non-dectable
Water solubles: <0.15%

Table 2 lists the quality requirement or recommend criteria for water purification from American Water Works Association (AWWS), FDA Codex of activated carbon for food grade applications and U.S. Pharmacopoeia (USP) for pharmaceutical grade application.

TABLE 2
Key Criteria of high quality Water Purification activated carbon

| | Iodine | Lead | Water | | N₂ BET | Pore | |
|---|---|---|---|---|---|---|---|
| | value | (Heavy | soluble | Total | specific | Volume | Apparent |
| Standard | mg/g | metal) | ash | ash | surface area | (N₂) | density |
| Value | >800 | <10 mg/Kg | <4% | <7% | >500 m2/g | >0.4ml/g | >0.36 g/ml |

### Conclusions:

It appears the methods of the present invention utilizing physical activation and ash removal can generate water purified activated carbon from pine wood biochar using steam activation at 810 C for 30 minutes, which appears to be much faster than current methods utilizing industrial steam activation of pine wood charcoal that takes longer than 3 hours or even several days. Additionally, the activated carbon appears to meet the qualifications for high-quality water purification activated carbon, specifically the ash content is less than 7% (2.1% herein), the BET specific surface area is greater than 500 m2/g (910 herein), and heavy metals less than 10 mg/Kg (non-detectable with the carbon produced herein).

### Example Two

### Chemical Activation of Biochar from Distilled Dried Grain and Solubles Protocol

High ash biochar from distilled dried grain and solubles (“DDGS”) was produced. DDGS is a co-product from corn ethanol, which is sold for $150˜200/ton as animal feed. In general, pyrolysis can produce 15˜30% weight biochar, which equates to approximately 15˜30 gram biochar from 100 grams of DDGS.

Table 3 illustrates the properties of the DDGS biochar produced from the initial DDGS biomass.

TABLE 3

| | | Vola- | Mois- | | | | | | Surface |
|---|---|---|---|---|---|---|---|---|---|
| Biomass | Pyrolysis | tile % | ture % | N % | C % | C/N | Ash % | Density | area m²/g |
| DDGS | Slow pyrolysis | — | 3.2 | 6.2 | 61.5 | 9.60 | 57.16 | 0.42 | 8 |
| | 600 C. for | | | | | | | | |
| | 45 minutes | | | | | | | | |

A catalyst was formulated with 10% wt KOH (potassium hydroxide), 20% NaOH (sodium hydroxide), 30% K₂CO3 (potassium carbonate), and 40% Na₂CO₃ (sodium carbonate). It was then mixed with water to form a 20% wt catalyst solution. The biochar was then added to the catalyst solution at a ratio of 1 gram biochar to 2.7 gram catalyst solution (solids). Briefly, for 10 grams biochar, approximately 135 grams catalyst solution was added.

The mixture was then milled with a high speed stirring dispense mill (containing ZrO₂ beads 0.2 mm, 50 ml) at 4000 rpm for 24 hr at 25 C, cooling with recycling water. After milling and mixing, the resultant mixture was then poured out and filtered through 0.1 mm stainless steel mesh to remove the ZrO₂ beads. It was then dried at 105 C for 24 hours with air flow at 20 L/min in a 120 L convention oven.

The dried mixture was then placed in a steel crucible (200 ml) with the cover loosely placed prior to the crucible being placed in a muffle furnace with N₂ flow (0.5 L/min). The heat was then set at 950 C with a heating rate of 10 C/min and N₂ flow was kept at 0.5 L/min. The mixture was then kept at 950 C for 1 hour and the N₂ flow was kept at 0.5 L/min.

The N₂ flow was then turned off and a CO₂ flow added at 0.5 L/min for 30 minutes. The CO₂ flow was then turned off, the target temperature decreased to 25 C, and the N₂ turned back on at 0.5 L/min till cooling to 100 C, which took approximately 5 hours.

The samples were then taken out, put in a vacuum desiccator and allowed to cool to room temperature, i.e. 25 C.

After cooling the sample to 25 C, it was then mixed with 500 ml DI water, filtered using a 2 um (micron-meter) regenerated cellulose membrane and was continually washed with 5000 ml water as it was being vacuum filtered to a pH of 7. The wet sample was then taken out, the filter membrane removed and 100 ml 0.2 molar/L HCl was then added to the sample prior to boiling it with condensing-reflux for 2 hours while stirring at 500 rpm using a stirring bar and stirring/heating plate.

The samples were then allowed to cool to room temperature, filtered with 0.2 um PTFE membrane, and washed with water under vacuum till the pH of the filtrate was 7. The sample was then taken out, dried at 105 C for 24 hours and stored in a vacuum desiccator.

### Analysis:

Samples were analyzed as described in Example 1. The prepared super activated carbon appeared to have the following properties:

| Yield | Yield of | Apparent | | | | | Pore | Methylene | Iodine |
|---|---|---|---|---|---|---|---|---|---|
| (total | fixed carbon | density | SSA | V total | V meso | V micro | size/ | blue adsorp- | value |
| mass) % | % | g/ml | m2/g | m2/g | m2/g | m2/g | nm | tion mg/g | mg/g |
| 45% | 90% | 0.25 | 3250 | 1.750 | 1.163 | 0.587 | 2.69 | 600 | 1850 |

### Conclusions:

It appears that the methods of the present invention can produce similar surface area and pore structures as prior methods utilizing pure KOH (>95% wt pure) and starting biomass materials, such as artificial polymers, pure lignin, pure cellulose or high quality feedstocks such as coconuts shell, hardwood (ash less than 10%° wt). The methods of the present invention appear to produce similar results in a shorter period of time utilizing lower quality, readily-available, lower-cost starting materials.

### Example Three

### Chemical Activation of Additional Biochar

Similar super-activated carbon was produced from other biochars using the same activation protocol described in Example Two. Results are illustrated in Tables 4 and 5.

TABLE 4

| | | | | | | | surface |
|---|---|---|---|---|---|---|---|
| Biochar | | Pyrolysis | Vola- | Mois- | Carbon | | area |
| ID | Biomass | processes | tiles % | ture % | % | Ash % | m²/g |
| CS | Corn | microwave | 21.51 | 1.05 | 55.2 | 19.81 | 38 |
| | stover | pyrolysis 650 | | | | | |
| | | C., 45 min | | | | | |
| SWG | Switch | microwave | 11.31 | 1.3 | 55.58 | 12.30 | 42 |
| | grass | pyrolysis 650 | | | | | |
| | | C., 45 min | | | | | |
| RH | Rice husk | Gasification at | 9.21 | 0.32 | 50.31 | 40.85 | 105 |
| | | 750 C. 30 min | | | | | |
| WB | 8wheat | Gasification at | 15.2 | 2.53 | 55.35 | 27.98 | 35 |
| | bran | 750 C. 30 min | | | | | |
| BB | 3Big | Slow pyrolysis | 11.32 | 1.6 | 45.33 | 29.23 | 35 |
| | bluestem | 600 C. 45 min | | | | | |

TABLE 5

| | Apparent | | V | V | V | Pore | Methylene | Iodine |
|---|---|---|---|---|---|---|---|---|
| | density | SSA | total | meso | micro | size/ | blue adsorp- | value |
| Biochar | g/ml | m2/g | m2/g | m2/g | m2/g | nm | tion mg/g | mg/g |
| CS | 0.21 | 1710 | 0.85 | 0.40 | 0.45 | 2.21 | 380 | 1180 |
| SWG | 0.17 | 2550 | 1.65 | 1.20 | 0.45 | 2.59 | 450 | 1350 |
| RH | 0.20 | 1750 | 0.94 | 0.75 | 0.15 | 2.30 | 370 | 1150 |
| WB | 0.35 | 1800 | 1.01 | 0.75 | 0.26 | 2.50 | 400 | 1200 |
| BB | 0.18 | 2300 | 0.95 | 0.80 | 0.15 | 1.90 | 420 | 1300 |

### Example Four

### Production of Activated Carbon with Similar Structure to Graphene

The methods of the present invention also appeared to produce activated carbon with a similar structure to activated graphene using DDGS biochar as a starting feedstock in conjunction with chemical activation. Results are illustrated in Table 6 and FIGS. (1 and 2). This activated carbon product demonstrated a high surface area, mesopore rich porous structure and a structure similar to graphene.

TABLE 6

| | | Solid | | Ash remove | Yield (base | Yield base on | | V | V | V | Pore |
|---|---|---|---|---|---|---|---|---|---|---|---|
| Catalyst | Sample | Catalyst/ | | after | on biochar) | fixed carbon | SSA | total | meso | micro | size/ |
| type | ID | biochar (g/g) | Temp | activation | % | % | m2/g | m2/g | m2/g | m2/g | nm |
| Pure | DDG1 | 2.8 | 950 | Yes | 44.33 | 90.56 | 3318 | 1.623 | 1.022 | 0.601 | 2.39 |
| KOH | DDG2 | 2.8 | 1050 | Yes | 37.67 | 88.21 | 2950 | 2.135 | 1.820 | 0.315 | 4.7 |
| | DDG3 | 1.4 | 950 | Yes | 53.67 | 95.72 | 1657 | 0.85 | 0.39 | 0.46 | 2.15 |
| | DDG4 | 0.85 | 950 | Yes | 52.33 | 96.31 | 1468 | 0.74 | 0.31 | 0.43 | 2.1 |
| | DDG5 | 5.6 | 950 | Yes | 28.00 | 57.11 | 2642 | 2.76 | 2.7 | 0.06 | 5.0 |
| | DDG6 | 4.2 | 950 | Yes | 29.00 | 58.20 | 1977 | 2.17 | 1.6 | 0.57 | 4.5 |
| | DDG1n | 2.8 | 950 | Not | — | — | 318 | — | — | — | — |
| Pure | DDG7 | 2 | 950 | Yes | 41 | 89 | 2366 | 1.32 | 0.88 | 0.44 | 2.35 |
| NaOH | DDG8 | 1 | 950 | Yes | 42.3 | 85.1 | 1800 | 0.88 | 0.61 | 0.27 | 1.96 |

Activated carbons produced in this manner may be useful for electrical and natural gas energy storage and will also help improve the economic viability of the biofuel manufacturing process. Additionally, the methods discussed above are useful for the production of activated carbons from protein rich feedstocks with a structure similar to activated graphene.

### Example Five

### Physical Activation in Conjunction with Removable Template

The methods of the present invention also appeared to produce activated carbon using prairie cord grass as a starting feedstock in conjunction with physical activation.

### Protocol:

The prairie cord grass was processed at 650 C for one hour to create the starting biomass. Details of pyrolysis procedure and outcome are below:

TABLE 7

| | | | | | | surface |
|---|---|---|---|---|---|---|
| | Pyrolysis | Volatiles | Mois- | Carbon | Ash | area |
| Biomass | processes | % | ture % | % | % | m²/g |
| 1# | pyrolysis | 13.34 | 1.2 | 55.21 | 12.30 | 41 |
| Prairie | at 650 C. | | | | | |
| cord | for 1 hr | | | | | |
| grass | | | | | | |

Pretreatment: The biochar was then dried at 100 C for 12 hours in an oven to remove all moisture prior to being pretreated with a Na₂SiO₃ solution, concentration at 20% wt. The final ratio of Na₂SiO₃:Biochar was 0.5:1 (w:w). The mixture of Na₂SiO₃ and Biochar was then dried at 120 C for 12 hours to remove all water.

Activation: Thirty grams of the dried mixture of Na₂SiO₃ and biochar were then placed in a reactor fabricated with a 316 stainless steel screen (80 mesh) and the reactor was then placed in a muffle furnace at room temperature. The muffle furnace was equipped with one gas inlet and one gas outlet. The N₂ flow was at approximately 0.5 L/min, connected into the muffle furnace. The heat was then set for 810 C at a rate of 10 C/min with the nitrogen flow maintained at 0.5 L/min. After the temperature of 810 C was achieved, the water flow was immediately turned on at a rate of 1 ml/min in conjunction with the N₂ flow being maintained to achieve steam activation. The biochars were then steam activated for 30 minutes. The reactor was then removed from the furnace, and immersed in an ice-water bath. After cooling, the activated carbon was then collected via vacuum filtration using quantification filter paper.

Ash Removal Process: The activated carbon was then mixed with 1 Mol/L NaOH in a glass beaker in a ratio of acid to carbon of 1 L:200 gram. The mixture was then shaken at 200 rpm at room temperature for 60 minutes. The carbon was then filtered using quantification filter paper while continually washed with DI water under vacuum filtration until the pH was 7. The activated carbon was then mixed with a 1 Mol/L HCl solution in a polyethylene beaker and the ratio of base solution to carbon was 1 L:200 gram. The solution was then shaken at 200 rpm at room temperature for 60 minutes. The carbon was then filtered using quantification filter paper while continually washed with DI water under vacuum filtration until the pH was 7. The carbon was then dried at 105 C overnight, weighed to calculate yield of activation and stored in a glass bottle in a vacuum desiccator.

### Analysis:

Samples were analyzed as described in Example 1. The prepared super activated carbon appeared to have the following properties:

TABLE 8

| Activation | Activation | Yield/ % | Yield % based | BET | Vmeso/ | D | Methylene | Iodine |
|---|---|---|---|---|---|---|---|---|
| Temperature/ | time | Based on | on fixed C | SSA | Vtotal | pore/ | blue adsorp- | value |
| C. | minutes | total biochar | in biochar | m2/g | ml/g | nm | tion mg/g | (mg/g) |
| 810 | 30 | 37% | 76% | 1200 | 0.45/0.67 | 2.79 | 300 | 1250 |

Apparent Density of this activated carbon (listed above): 0.32 g/ml

### Total ash: <5.1%

Total volatile (at 900 C, 15 minutes): <0.1%
Heavy metals (by atoms fire spectroscopy): non-dectable
Water solubles: <0.15%

### Example Six

### Physical Activation and Ash Removal of High Ash Woody Biochar

The methods of the present invention also appeared to produce activated carbon using high ash woody biochar from pine wood as feedstock in conjunction with physical activation. The starting feedstock appeared to contain approximately 15% ash and 12% volatiles similar to that found in Example 1.

### Protocol:

The high ash woody biochar from pinewood was activated at 810 C for 30 minutes using 30 ml water steam after modifying the ash content of the biomass. Details of the ash removal procedure and outcome are below and are similar to the protocol detailed in Example One.

| | Yield | BET | Vmeso/ | D | | |
|---|---|---|---|---|---|---|
| | % of | SSA | Vtotal | pore/ | MB | Iodine |
| pretreatment | fixed C | m2/g | ml/g | nm | (mg/g) | (mg/g) |
| HCl 1 mol/L, 1 g char/5 ml acid solution, | 48.56% | 760 | 0.218/0.530 | 2.21 | 75 | 635 |
| ultrasonic for 30 minutes, then washed | | | | | | |
| with water till pH = 7 | | | | | | |
| NaOH 1 mol/L, 1 g char/5 ml base solution, | 28.43% | 563 | 0.244/0.525 | 2.59 | 105 | 580 |
| ultrasonic for 30 minutes, then washed | | | | | | |
| with water till pH = 7 | | | | | | |
| HCl 1 mol/L, 3 g char/5 ml acid solution, | 35.64% | 692 | 0.270/0.557 | 2.42 | 120 | 509 |
| shaking at 200 rpm for 1 hr, then washed | | | | | | |
| with water till pH = 7, continue with NaOH | | | | | | |
| 1 mol/L, 1 g char/5 ml base solution, shaking | | | | | | |
| at 200 rpm for 1 hr then washed with water | | | | | | |
| till pH = 7 | | | | | | |
| Without pretreatment | 21.77% | 793 | 0.502/0.553 | 2.43 | 150 | 704 |
| water wash: 1 g char/5 ml water, ultrasonic | 48.36% | 692 | 0.28/0.560 | 2.50 | 135 | 662 |
| for 30 minutes | | | | | | |

The ash removal pretreatment appeared to have the ability to improve the final activated carbon yield, and also to decrease the mesopore volume and percentage of mesopore (the total pore volume includes both micropore and mesopore volume) when compared to samples not subjected to an ash modification step.

### Example Seven

### Chemical Activation in Conjunction with Removal of Volatiles

High ash woody biochar from pine wood containing 15% ash and 12% volatiles was used as feedstock that was then activated with pure KOH, the KOH/char=2.8 g/g according to the procedure outlined in Example Two. It appeared that chemical activation in combination with removal of volatiles can generate a higher surface area, higher pore volume and higher adsorption capacity in the resulting activated carbon product. Results are shown below:

| | Yield of | Apparent | | V | V | V | Pore | Methylene | Iodine |
|---|---|---|---|---|---|---|---|---|---|
| | fixed | density | SSA | total | meso | micro | size/ | blue adsorp- | value |
| Devolatile | carbon % | g/ml | m2/g | m2/g | m2/g | m2/g | nm | tion mg/g | mg/g |
| without | 75% | 0.31 | 950 | 0.35 | 0.10 | 0.25 | 2.3 | 150 | 850 |
| Devolatile | 70% | 0.29 | 1182 | 0.61 | 0.29 | 0.32 | 2.1 | 375 | 1205 |
| in N2 flow | | | | | | | | | |
| 50 ml/min, | | | | | | | | | |
| 900 C. for 1 | | | | | | | | | |
| hr | | | | | | | | | |

### Example Eight

### Physical Activation Utilizing Steam or CO2

High ash woody biochar from pine wood containing 15% ash and 12% volatiles without any pretreatment was physically activated with steam or CO2 according to the protocol of Example One. The results are below:

| | t/min. | | Yield % | BET | Vmeso/ | D | | |
|---|---|---|---|---|---|---|---|---|
| Tem/ | water/ | | of fixed | SSA | Vtotal | pore/ | MB | Iodine |
| C. | ml | Yield/% | C | m2/g | ml/g | nm | (mg/g) | (mg/g) |
| 750 | 20 | 66.00% | 62.64% | 650 | 0.259/0.370 | 1.92 | 60 | 635 |
| 750 | 30 | 56.67% | 52.38% | 700 | 0.263/0.387 | 2.20 | 75 | 750 |
| 750 | 40 | 49.33% | 44.32% | 730 | 0.280/0.406 | 2.38 | 90 | 810 |
| 800 | 20 | 66.33% | 63.00% | 650 | 0.260/0.404 | 2.30 | 105 | 670 |
| 800 | 30 | 54.00% | 49.45% | 735 | 0.282/0.503 | 2.37 | 105 | 770 |
| 800 | 40 | 46.67% | 41.39% | 810 | 0.320/0.535 | 2.42 | 135 | 880 |
| 820 | 40 | 42.33% | 36.63% | 854 | 0.359/0.545 | 2.57 | 150 | 950 |
| 820 | 60 | 29.00% | 21.98% | 774 | 0.373/0.526 | 2.75 | 195 | 810 |
| 820 | 20 | 66.00% | 62.64% | 720 | 0.310/0.506 | 2.43 | 105 | 780 |
| 850 | 60 | 15.33% | 10.88% | 888 | 0.610/0.644 | 2.94 | 195 | 1070 |
| 850 | 20 | 58.33% | 56.14% | 730 | 0.332/0.523 | 2.32 | 90 | 800 |
| 850 | 40 | 32.67% | 29.12% | 750 | 0.353/0.516 | 2.65 | 150 | 820 |
| 810 | 30 | 46.40% | 41.52% | 910 | 0.585/0.416 | 2.59 | 150 | 1150 |

CO2 flow 1.3 L/in

800 C.

| Duration (min) | Conversion (%) | Yield (%) | BET | Pore Vol. |
|---|---|---|---|---|
| 20 | 29.85 | 70.15 | 589.34 | 0.4532 |
| 30 | 37.66 | 62.34 | 486.75 | 0.3124 |
| 45 | 50.42 | 49.58 | 665.96 | 0.4990 |
| 80 | 77.14 | 22.86 | 563.72 | 0.4632 |

850 C.

| Duration (min) | Conversion (%) | Yield (%) | BET | Pore Vol. |
|---|---|---|---|---|
| 20 | 30.59 | 69.41 | 591.96 | 0.3160 |
| 40 | 48.10 | 51.90 | 656.77 | 0.3933 |
| 60 | 68.83 | 31.17 | 704.40 | 0.5351 |
| 80 | 80.60 | 19.40 | 523.84 | 0.4571 |

900 C.

| Duration (min) | Conversion (%) | Yield (%) | BET | Pore Vol. |
|---|---|---|---|---|
| 20 | 36.58 | 63.42 | 499.183 | 0.2674 |
| 40 | 58.95 | 41.05 | 640.157 | 0.4015 |
| 60 | 81.82 | 18.18 | 638.46 | 0.5154 |

### Example Nine

### Chemical Activation with Other Catalysts

A variety of biochars were chemically activated for 950 C for one hour in the presence of a variety of catalysts. Results are indicated below.

| | Catalyst/load | Temper- | | V | V | V | Pore | Methylene | Iodine |
|---|---|---|---|---|---|---|---|---|---|
| | (catalyst g/g | ature C./ | SSA | total | meso | micro | size/ | blue adsorp- | value |
| Biochar | biochar) | time hr | m2/g | m2/g | m2/g | m2/g | nm | tion mg/g | mg/g |
| CS | NaHCO3 | 950 C./1 | 487 | 0.29 | 0.279 | 0.011 | 5.5 | 155 | 560 |
| | 4 g/1 g | hr | | | | | | | |
| RH | Na2CO3 | 950 C./1 | 458 | 0.38 | 0.27 | 0.11 | 3.5 | 175 | 600 |
| | 2 g/1 g | hr | | | | | | | |
| BB | NaHCO3 | 950 C./1 | 750 | 0.35 | 0.30 | 0.05 | 4.5 | 165 | 750 |
| | 4 g/1 g | hr | | | | | | | |
| PCG | K2CO3 | 950 C./1 | 1500 | 0.75 | 0.32 | 0.43 | 2.15 | 255 | 1250 |
| | 2 g/1 g | hr | | | | | | | |

### Example Ten

### Chemical Activation Followed by HNO₃ Surface Oxidation

Activated carbon was produced according to the protocol illustrated in Example Two above.

Alternatively, biochar was also generated from the pyrolysis of DDGS through activation with KOH (KOH/biochar=0.075 mol/g) in a nitrogen inert atmosphere at 950 C. The DDGS pyrolysis process was then optimized for bio-oil production, rather than biochar production. Samples were then mixed with a solution of KOH and dried in a conventional oven at 105 C for 48 hours. Further drying was conducted at 400 C in a muffle furnace (chamber of furnace utilized was 15×15×22 cm) in a nitrogen atmosphere (nitrogen flow was 500 ml/min) for six hours to remove structural water.

Activation was then done at 950 C with a heating rate of 5 C per minute for three hours. Samples were then cooled in the furnace in the same nitrogen atmosphere. Approximately 9 hours later when the samples were cooled to room temperature, they were washed with 0.1 mol/litre HCL at 100 C with condensing, then washed with deionized water to pH 7 and dried at 105 C overnight under vacuum.

Whether samples were produced by the method of Example Two or the one detailed above, the resulting carbon samples were then treated with 4 M HNO₃ at 150 C. In one particular experiment, approximately 1 gram of carbon was soaked in 20 ml 4 mol/litre HNO₃ in a sealed PTFE reactor (50 ml) at 150 C for 48 hours, cooled and then filtered before being washed with water until the filtrate had a pH of 7. The filter cake was then dried in the oven with a temperature of 110 C for overnight.

The activated carbon produced by this method appeared to have a high specific surface area (illustrative samples had 2959 m³/g), high pore volume (illustrative samples had 1.65 cm²) and improved specific capacitance (illustrative examples demonstrated 150 and 70 F/g in 1 mol/L tetraethylammonium tetrafluoroborate in acetonitrile and 260 F/g in 6 mol/L KOH at a current density of 0.6 A/g) when compared to activated carbon without oxidation that appears to exhibit relatively high specific capacitance (illustrative samples had 200 F/g) at a higher current density (0.5 A/g) after 2000 cycles. The capacitive performances of the treated activated carbons also appeared to be much better than general bio-inspired activated carbons, ordered mesoporous carbons and commercial graphene. The treated activated carbons produced by this method also appear useful for use in preparing high-performance supercapacitor electrode materials from biochar, as well as a way to provide an economically valuable end-product from the thermochemical biofuel manufacturing process.

All of the COMPOSITIONS, METHODS and APPARATUS disclosed and claimed herein can be made and executed without undue experimentation in light of the present disclosure. While the compositions and methods of this invention have been described in terms of particular embodiments, it will be apparent to those of skill in the art that variations may be applied to the COMPOSITIONS, METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method of producing activated carbon from biochar comprising;
a. modification of the ash content and distribution in said biochar; and
b. physical activation of said modified biochar, wherein said activated carbon has particular surface area and pore characteristics.

2. The method of claim 1, wherein said activated carbon has a high total pore volume and mesopore volume.

3. The method of claim 1, wherein said modification is done with a solution selected from the group consisting of water, one or more acids and one or more bases.

4. The method of claim 3, wherein said acid is selected from the group consisting of hydrochloric acid, hydrofluoric acid, hydrobromic acid, nitric acid, sulfuric acid, phosphoric acid, acetic acid, citric acid, perchloric acid and sulfurous acid.

5. The method of claim 3, wherein said base is selected from the group consisting of sodium hydroxide, potassium hydroxide, calcium hydroxide, sodium carbonate, potassium carbonate, sodium bicarbonate, potassium bicarbonate and ammonia hydrate.

6. The method of claim 1, wherein said physical activation asserts control over a condition selected from the group consisting of heating, temperature of activation, activation reagents, the flow rate of activation reagents, the mass/molar ratio of activation reagents to biochar and the activation time itself.

7. The method of claim 1, further comprising control of the volatile composition of the biochar.

8. The method of claim 1, further comprising catalyst loading and chemical activation.

9. The method of claim 8, further comprising removal and recycling of the catalysts.

10. The method of claim 8, wherein said activated carbon has a hierarchical porous structure.

11. The method of claim 10, wherein said activated carbon can be used for a purpose selected from the group consisting of super-activated carbon for natural gas storage, hydrogen storage, and electrical energy storage in a battery or supercapacitor.

12. A method of producing activated carbon from biochar comprising;
a. modification of the ash content and distribution in said biochar;
b. catalyst loading;
c. chemical activation of the biochar; and
d. removal and recycling of the catalyst, wherein said activated carbon has particular surface area and pore characteristics.

13. The method of claim 12, wherein said activated carbon has a high total pore volume and mesopore volume.

14. The method of claim 12, wherein said modification is done with a solution selected from the group consisting of water, one or more acids and one or more bases.

15. The method of claim 14, wherein said acid is selected from the group consisting of hydrochloric acid, hydrofluoric acid, hydrobromic acid, nitric acid, sulfuric acid, phosphoric acid, acetic acid, citric acid, perchloric acid and sulfurous acid.

16. The method of claim 14, wherein said base is selected from the group consisting of sodium hydroxide, potassium hydroxide, calcium hydroxide, sodium carbonate, potassium carbonate, sodium bicarbonate, potassium bicarbonate and ammonia hydrate.

17. The method of claim 12, wherein said catalyst is selected from the group consisting of hydroxides of alkali metals, carbonates of alkali metals, bicarbonates of alkali metals, nitrates of transition metals and mixtures thereof.

18. The method of claim 12, further comprising control of the volatile composition of the biochar.

19. The method of claim 12, further comprising physical activation.

20. The method of claim 12, further comprising treatment of said activated carbon with HNO₃.
